(19) United States
(12) Patent Application Publication
(10) Pub. No.: US 2020/0138083 A1
(43) Pub. Date: May 7, 2020

(54) AUTOMATED PRODUCTION SYSTEM FOR EFFICIENT WALNUT SHELL-BREAKING, KERNEL-TAKING AND SHELL-KERNEL SEPARATION

(71) Applicants: QINGDAO UNIVERSITY OF TECHNOLOGY, Qingdao (CN); XINJIANG JIANGNING LIGHT INDUSTRY MACHINERY ENGINEERING TECHNOLOGY CO., LTD, Urumqi (CN)

(72) Inventors: Changhe LI, QINGDAO (CN); Mingzheng LIU, QINGDAO (CN); Ji CHE, QINGDAO (CN); Yali HOU, QINGDAO (CN); Yanbin ZHANG, QINGDAO (CN); Dongzhou JIA, QINGDAO (CN); Cai WANG, QINGDAO (CN); Pengfei YUAN, QINGDAO (CN); Yuan HONG, QINGDAO (CN)

(73) Assignees: QINGDAO UNIVERSITY OF TECHNOLOGY; XINJIANG JIANGNING LIGHT INDUSTRY MACHINERY ENGINEERING TECHNOLOGY CO., LTD

(21) Appl. No.: 16/711,722

(22) Filed: Dec. 12, 2019

Related U.S. Application Data
(63) Continuation of application No. PCT/CN2018/119448, filed on Dec. 6, 2018.

(30) Foreign Application Priority Data
Mar. 16, 2018 (CN) 201810220809.3

(51) Int. Cl. A23N 5/00; B03B 4/02; B03B 9/00

(52) U.S. Cl. CPC A23N 5/00; B03B 9/00; B03B 4/02

(57) ABSTRACT

The disclosure discloses an automated production system for efficient walnut shell-breaking, kernel-taking and shell-kernel separation, solving the problem that the existing walnut shell breaking device cannot adapt to walnuts having different sizes and shell breaking rate and shell breaking efficiency cannot be ensured. The system can realize efficient shell-breaking, kernel-taking and shell-kernel separation on different varieties of walnuts, is quick in production speed and high in automation degree, and meanwhile is capable of improving entire kernel rate and kernel obtaining rate, reducing the damage rate of the walnut kernel and ensuring the high shell-breaking efficiency and thoroughness of shell and kernel separation.

### CROSS-REFERENCE TO RELATED APPLICATIONS

This application is a continuation of International Patent Application No. PCT/CN2018/119448 with a filing date of Dec. 6, 2018, designating the United States, now pending, and further claims priority to Chinese Patent Application Nos. 201810220809.3 and 201820362636.4 with a filing date of Mar. 16, 2018. The content of the aforementioned applications, including any intervening amendments thereto, are incorporated herein by reference.

### TECHNICAL FIELD

The disclosure relates to the technical field of walnut shell breaking and kernel taking, and particularly to an automated production system for efficient walnut shell-breaking, kernel-taking and shell-kernel separation.

### BACKGROUND OF THE PRESENT INVENTION

Walnuts, referred to as Juglans and qiang Juglans, are known as the world's famous “four dried fruits” together with almonds, cashews and hazelnuts, belonging to a family of Juglans. Walnuts are perennial deciduous trees, and origins from Central Asia. Through continuous exploration and practice, the cultivation area of walnuts in China is more than 1.3 million kilometers, and both of its area and yield are the first in the world.

Each part of the walnut is precious walnut kernels are rich in nutrients and also contain many trace elements required by human body, which not only have a good health care effect on human body, but also prevent various diseases; the walnut shell is the endocarp of a matured Juglan fruit in the family of Juglans, and is a good traditional Chinese medicine. This product is bitter, astringent and smooth in taste, can enter the spleen, lung and kidney meridians, has the functions of clearing away heat and detoxifying, and astringing to stop bleeding, and is suitable for blood avalanche, mastitis and scabies. In addition, the walnut shell has the advantages of good hydrophilicity, oil immersion resistance and the like. The walnut shell is an ideal polishing and grinding material because it is good in durability and elasticity, and can be mixed and used with other abrasives. In the metal cleaning industry, the walnut shell can be used as a cleaning and polishing material of metals after being treated. For example, aircraft engines, circuit boards and gear units of ships and automobiles can be cleaned with treated walnut shells. The walnut shell has a certain elasticity, resilience and huge bearing capacity after being smashed into extremely fine particles, so it is suitable for polishing and grinding tools as an abrasive and finishing all kinds of hardware, jewelry and operating parts. Diaphragma juglandis, also known as Juglans coat, Juglans clip and Juglans septum, is a wood septum in the walnut kernel of the family of Juglans. According to traditional Chinese medicine, this product is bitter, astringent and smooth in taste, can enter the spleen and kidney meridians, has the function of strengthening the kidney and astringent essence, and can also prevent many diseases. Due to various advantages, the walnuts are more and more popular with and loved by people, so the increase amplitude of its production is more and more larger.

With the continuous increasing of walnut production and market demand, walnut deep processing has also become an increasingly prominent problem in scientific research and production. Breaking walnut shells and taking kernels is a primary premise of deep processing. Because the walnut shell is mainly composed of lignin, cellulose and hemicellulose, the walnut shell is hard and thick and irregular in shape, has multiple partitions therein and gaps between shells and kernels are small, which increases great difficulty for peeling the shells and taking kernels. Due to the lagging processing technology, there is no mature walnut shell breaking machinery. In order to ensure the shell breaking rate and the whole kernel rate, many walnut processing factories still manually break shells and take kernels, such as “a method for pealing pecan by hands”, that is, a hammer made of a flexible material is used to artificially knock Chinese walnuts in a mold. Furthermore, the existing shell breaking devices are difficultly suitable for households, and has the main disadvantages of huge size and high price.

The economic benefits of walnut products are closely related to the efficiency of breaking walnut shells and taking kernels. The higher the efficiency of breaking shells and taking kernels is, the higher the economic benefits are. High adaptability and high efficiency are competition focuses of contemporary walnut shell breaking and kernel taking machines. With the deepening of researches of scholars at home and abroad on mechanized walnut shell breaking devices, many new walnut shell peeling machines have appeared. The disadvantages of these shell breaking and kernel taking machines are that these machines omit peeling of walnut shells or incompletely break the shells, with low shell breaking rate, high loss rate, low efficiency and poor adaptability to different varieties of walnuts. For example, some shell breaking and kernel taking machines are low in walnut shell breaking rate, and high in whole walnut kernel rate; while for some shell breaking and kernel taking machines, the shell breaking rate is excessively increased, but the damage to walnut kernels is ignored, resulting in a high walnut kernel damage rate. At the same time, the adaptability of these shell breaking and kernel taking devices to different varieties of walnuts is poor, and the shell breaking effect of the device decreases when the size of the walnut changes.

In the prior art, there are mainly physical and chemical corrosion manners to break walnut shells and take kernels at present, among them, people are unwilling to accept the chemical corrosion manner because it is not well controlled in practical operation, walnut kernels are easily corroded, and meanwhile pretreatment and posttreatment processes of walnuts are increased, environment pollution can be caused if the walnuts are not well treated. At present, the most popular methods in the market are to utilize the physical characteristics of walnuts to break the shells and take the kernels, including a milling method, an impacting method, a shearing method, a squeezing method and an ultrasonic shattering method. The first four methods are that a certain gap existing between the walnut shell and the kernel is utilized to rigidly apply a pressure through a mechanical device to crush the shells, the walnut kernel can be protected from being damaged as long as the stroke of applying the force is less than the gap between the shell and the kernel. However, due to different varieties of walnuts, the sizes and shapes of walnuts and the hardnesses of the walnut shells are different, which results in a fact that the stress stroke of the walnut shell is not changeless, so the first four methods should consider problems of positioning or size grading of walnuts when breaking the shells. The fifth physical method, the ultrasonic shattering method, is to utilize ultrasonic waves to shatter the walnut shells so as to achieve the effect of shell and kernel separation. This method does not need to consider problems of size, shape, grading and positioning of walnuts. However, due to the immaturity of the method, it is difficult to ensure that the walnut kernels is not damaged to a certain degree while shattering the walnut shells.

Xinjiang Agricultural University invented a pneumatic walnut shell breaking machine, which consists of a rack, a transmission control device, a feeding mechanism and a shell breaking device. The rack is equipped with the shell breaking device composed of an impact cylinder and a holding cylinder connected between various splitter plates of a workbench. The transmission control device is arranged on the front lower part of the rack and consists of a motor, a shift wheel and a control cam coaxially sleeved with the shaft of the motor, a drive chain wheel and a Geneva wheel sleeved with the lower shaft, side-by-side front chain wheels and driven chain wheels sleeved with the upper shaft, side-by-side rear chain wheels arranged on the rear part of the rack, clamping, holding and hitting switches arranged on the rack on the lower part at intervals and driving and driven chain wheels, front and rear chain wheels are linked respectively through chains, and a material box is arranged at the rear of the workbench frame, one wall of the material box is provided with a slot, a feeding mechanism is arranged close to the lower part of the slot and composed of side-by-side chains, rotation rollers connected to the chains at intervals, rolling plates supporting the rotation rollers and a tensioning chain wheel.

The device has the disadvantages that the whole kernel rate is not high; the walnut needs to be positioned before processing, which causes great damage to walnut kernel; the device has many processing procedures, is low in shell breaking and kernel taking efficiency, and easily causes secondary damage to walnut kernels, and is high in manufacturing cost.

Dang Cai Liang, from Shangluo City, Shaanxi Province, invented a walnut shell breaking and kernel taking machine. The shell breaking part includes a piston sleeve in which a piston is arranged. The piston is connected with one end of the shell breaking spring, and the other end of the shell breaking spring is connected with the shell breaking spring positioning pillar. The shell breaking spring positioning pillar passes through the positioning hole on the piston sleeve. The shell breaking part also includes a piston pin which is perpendicular to the axis of the piston sleeve and connected with the piston. The shell breaking part also includes a spindle mounted on the piston sleeve and perpendicular to the axis of the piston sleeve, one end of the spindle is provided with a cam knife, the other end is a handle, the running curve of the cam knife rotating around the spindle can push the piston pin to move forward and backward in the limit hole on the piston sleeve and contact the piston with the stopper, the stopper is on the extension line of the central axis of the piston, and is fixedly installed on the piston sleeve. When working, piston movement is utilized to hit the walnut and the stopper to achieve the purpose of breaking the shells.

The device has the disadvantages that the continuous reciprocating impact puts forward high requirements on the spring. In addition, under the high-speed impact, the walnut kernel is easily damaged, the whole kernel rate is greatly reduced, and the adaptability to walnuts having different sizes is poor.

At present, in addition to methods of taking kernels by hands, there are several methods for breaking shells and taking kernels: a centrifugal impact shell breaking method, a chemical corrosion method, a vacuum shell breaking and kernel taking method, an ultrasonic shell breaking method and a mechanical shell breaking method. The first method is that the centrifuged walnut impacts the wall at a high speed to deform the shell until it is broken, but many broken kernels are generated after breaking the shell, so this method is not ideal; the second method is that the dosage of an agent is not easy to control in actual operation, the walnut kernels are easily corroded, and environmental pollution is also caused if well treatment is not achieved, so this method is rarely used; the third and fourth methods are expensive in device, too high in shell breaking cost and not ideal in shell breaking effect. The fifth method is simple in equipment and low in cost, the shell breaking effect can be improved by improving the structures of components, and therefore, this method has been increasingly explored, researched and applied.

A large number of experiments have been carried out on apricot kernel, pine nut and other nuts at home and abroad. The mechanical properties of nuts and the factors affecting the shell breaking effect are explored. It is pointed out that the factors such as moisture content and loading direction have certain influence on the shell breaking force, deformation, shell breaking tendency and whole kernel rate of nuts. Shi Jianxin, Wu ziyue and others researched the shell breaking principle and mechanical properties of walnuts in combination with a finite element analysis method through a large amount of experiments and found the optimal force applying position and way when breaking the shell. Yuan qiaoxia found that too large or too small spacing is not conducive to shelling through the experimental study of a roller plate type ginkgo shelling device. When the distance is too large, the squeezing amount can not reach the critical squeezing amount needed for breaking the shell, and the shelling rate decreases; when the distance is too small, the squeezing amount is too large, and the shell breaking rate increases. Li Zhongxin et al., who were inspired by the experiments of constant gap extrusion (transverse extrusion and longitudinal extrusion), established the “cone basket type shell breaking model”, studied the most effective direction and position of the force applied to the walnut shell breaking, and put forward the structural factors of the shell breaking machine, such as the influence of the shell breaking gap, the hardness of the shell breaking plate and the feeding speed on the shell breaking effect. Song zhizhan from Hefei University of technology analyzed the internal force and displacement by using the thin shell theory and fracture theory, and pointed out that two pairs of normal forces are more conducive to the shell breaking. At the same time, he pointed out that the shell breaking of Euryale ferox by the way of kneading should design the washboard into the shape consistent with the nut after deformation, that is, the washboard should have certain flexibility and hardness, and the large friction coefficient between the washboard and Euryale ferox should be selected to meet the requirement of shelling.

At present, the common mechanical shelling devices in China are divided into four categories according to shelling methods: a squeezing method, an impact method, a shearing method and a twisting method. The walnut shell breaking machine researched by Wu ziyue adopts a principle of double tooth disc and tooth plate shelling. After the walnuts are fed into the shell breaking device, the circular tooth disc drives the walnuts to rotate and squeeze into the gap, and the tooth tips at a certain distance constantly squeeze the surface of the shell, so that the cracks continue to expand. Finally, the walnut shell is basically completely broken, and the broken shells and the walnut kernels fall out through the minimum gap. The counter roller socket type walnut opening machine researched and developed by Zhang zhongxin mainly consists of two parts: a cone roller type grading device and a counter roller socket type opening device. The grading device consists of a pair of cone-shaped rollers with large end to large end and small end to small end, and the gap between the two rollers gradually increases from large end to small end. A pair of cylindrical squeezing rollers with the same diameter are used as the opening device of the opposite drum socket type, on which the socket is provided, and the size of the socket gradually increases from the large end to the small end. The two pairs of idlers roller roll oppositely, and the graded walnuts fall into the corresponding holes and are crushed under the squeezing of the two rollers, and then collected by the discharging slide plate. A centrifugal walnut secondary shell breaking machine developed by Wang Xiaoxuan^{[21]} and others utilizes the impact method to break walnuts. Under the action of friction force of the supporting plate and pushing of the paddle plate, the walnut falling on the centrifugal plate rotates with the centrifugal plate. When the centrifugal plate reaches a certain speed, the walnut can fly out at a certain speed and collide with the impact barrel to complete the shell breaking. By adjusting the rotating speed of the centrifugal plate, the impact force of walnut can be adjusted, and the ideal shell breaking effect can be obtained. The walnut shell breaking and kernel taking machine developed by Zhang Yong consists of a base and a top cover. The top half of the base is a round table with a concave shell stripping cavity on the top surface and a circle of serrations on the inner edge. When working, the walnut is put on the serrations of the shelling cavity, the walnut is pressed with the top cover with a rubber pad, the motor is started to saw out a gap of the walnut shell, and then the walnut shell is peeled after sawing out 4 to 6 gaps. The walnut shell breaking machine developed by Chai Jinwang utilizing the principle of friction and twisting uses internal and external mills with teeth grooves to break the walnut shell. The external mill is fixed on the rack, and the internal mill rotates under the drive of the motor. The walnut shell is broken and shelled in the gap between internal and external mills. When crushed to a suitable particle size, the gap between the baffle and the lower bottom of the internal mill falls to the blanking plate. The machine can not automatically adapt to the size of walnuts, and because of different varieties and sizes of walnuts at present, there are some defects in the practical application. If different sizes of walnuts are broken, different sizes of internal and external diameters need to be changed.

However, the main problems of the most shell breaking machines are that shell breaking rate is low, many shell breaking machines can omit shell breaking or cannot completely break shells, and shell breaking rate is 80% or even lower, loss rate is high and kernel taking rate is low. Due to incomplete shell breaking, partial broken walnut kernels are brought in the broken shells to be difficultly taken, the kernel loss rate of some shell breaking machines is up to 20%, while the high kernel taking rate is about 60%; the kernel integrity is poor, some shell breaking machines only seek to improve the shell breaking rate, so as to result in high walnut kernel breaking rate; adaptability is poor, when the variety, size, shell shape and other factors of the walnut change, the shell breaking performance of the shell breaking machines becomes worse. The shell breaking gaps of the most mechanical shell breaking devices are fixed, and because of irregular shapes and sizes of walnuts, walnuts are put in batches, and the shells of walnuts that do not meet the gap size often cannot broken. If the size of walnuts is too large, too large walnut size causes walnut shells to be excessively broken so that walnut kernels are damaged, and too small walnut size lead to a fact that walnut shells cannot be broken, and therefore, there is a need to grade sizes of walnuts before shell breaking. At present, there are three mechanical devices for walnuts in a mechanical manner, including 1) a roller type grading machine in which all the rollers are parallel to the horizontal plane, and the distance between the rollers increases from small to large. When the walnuts roll on the rollers, when the distance between the rollers exceeds the diameter of the walnut, the walnut falls into a corresponding separating groove below; 2) a double-roller type grading machine in which two rollers are inclined to the horizontal plane at a certain angle, and the two rollers are rotated relatively at a certain angle. Due to the angle between the two rollers, the grading space between the two rollers increases gradually, walnuts roll down along seams under the action of gravity, When the distance between the two rollers is larger than the diameter of walnut, walnuts fall into the separating groove from the two rollers; 3) a drum type classifier, there are several layers of drum units in the drum, each layer of drum unit is evenly covered with small holes, the hole diameters in the same layer of drum are the same, the hole diameters in different layers of drum are different, and the hole diameter in each layer increases from inside to outside in turn. The drum rolls at a constant speed, and the walnut is fed from the upper part of the drum and conveyed along the outer surface of the drum. The walnuts pass through the drum with different layer apertures in turn, and are graded from small to large.

The shell and kernel separation is one of difficulties in breaking walnut shell and taking kernels. There are few ideal separation methods and equipment in China. Although the existing methods and equipment can realize shell and kernel separation, but the equipment cost is high, the process is complex, and the separation rate is low. At present, the main devices of separating walnut shells from kernels by mechanical method are as follows: cashmere roller shell and kernel separation device. The device is composed of a pair of full-length rollers contacting each other, the roller surface is covered with flannelette, rotates relative to each other and tilts relative to the horizontal plane. When the walnut shell and kernel mixture is fed from the high end, the smooth walnut kernel is not easily stuck by the fluff and fall into the groove between the two drums and slide down until it is discharged from the bottom. The rough walnut shell is stuck by the fluff and finally climbs over the fluff drum and falls into the discharge hopper. In order to achieve a certain separation effect, the device generally has multiple fluff roller components for repeated separation. Because the broken ends of walnut shell and kernel have burrs, they can be adhered by plush, so the separation effect of the device is not good. Dong Yuande and others developed the walnut shell and kernel air separator to separate the walnut shells from kernels using the principle of air separation. The results show that the air volume and the length of the air cavity have a significant effect on the content of kernel in the shell, the length of the air cavity has a significant effect on the content of kernel in the shell, and the feeding amount has a significant effect on the loss rate of kernel in the high road.

The research team of Professor Li Changhe from Qingdao University of technology performed in-depth and systematic research on walnut shell breaking and kernel separation technology and equipment, walnut grading and walnut shell kernel separation. The walnut shell breaking and kernel taking device is designed and developed, which is automatic as a whole, and the shell breaking rate is greatly improved. Liu Mingzheng and Zhang Yanbin improved the walnut shell breaking and kernel taking device. The experiment shows that the shell breaking rate of walnut is 98%, the breaking rate of walnut kernel is 2.9%, and the exposing rate of walnut kernel is 70%, which further improves the shell breaking rate of walnut and reduces the breaking rate of walnut kernel. The separation rate of walnut and kernel is 97%, and the separation effect is ideal. Liu Mingzheng, et al. Designed and studied the revolving cage and swinging walnut grading screen, which can not only prevent the walnut from getting stuck in the pile, but also make the walnut with the size corresponding to the gap fall down sufficiently, and improve the grading efficiency and precision. Liu Mingzheng and others improved the design of the working belt in the walnut shelling and kernel taking device, which reduced the breaking rate of the walnut, improved the integrity of the walnut kernel, reduced the loss of the walnut kernel effectively increased the friction between the inner side of the belt and the idler, prevented the slip between the belt and the idler, and realized the stable work of the synchronous belt. Ma Zhengcheng, Xing Xudong, etc. invented a walnut breaking device and its use method. The device includes at least one walnut fixing mechanism and at least two impact rods, the walnut shell breaking mold is provided with a walnut positioning hole, the side wall of the walnut shell breaking mold is provided with at least two holes connected with the positioning hole of the kernel, and a plurality of impact rods are driven by the moving mechanism to pass through each impact rod. The hole corresponding to the rod impacts the walnut set in the positioning hole of the walnut, which also includes the positioning quantitative feeding slider set at both sides of the positioning hole of the walnut to cover the positioning hole of the walnut; the walnut in the positioning hole or the positioning groove of the walnut is impacted by the impact rod, and then matched with the setting of the slider, the impact speed is fast, and the kernel integrity rate is high; the invention uses the positioning quantitative feeding slider. The fast and stable feeding of walnuts is realized by periodic reciprocating motion, which makes full use of the efficiency of machine processing walnuts, realizes the automation and automation of walnuts feeding, reduces the labor cost and improves the processing efficiency.

A device for breaking walnut shells by shearing and squeezing and taking kernels by flexibly beating invented by Liu Mingzheng and others consists of three parts: a shearing, squeezing and shell breaking system, a flexible blade beating and kernel taking system and a pneumatic spiral blade drum separation system. Under the action of metal bracket and two working belts with speed difference, the force of shearing and squeezing is exerted on the walnut to break the walnut shell and expose the walnut kernel. Because the belt is flexible, the damage to the walnut kernel is reduced. Moreover, the walnut kernel embedded in the walnut shell can be further separated through the hammering system of flexible leaves. The leaves are made of flexible materials. The spiral curved surface can reduce the damage to walnut kernel during the hammering process, and can also play a role in the transportation of mixed materials, so as to avoid the direct falling of materials and the shattering of walnut kernel. The separation system can realize the automation of shell and kernel separation. By using height adjusting device, the device can be adapted to deal with different sizes of walnuts, so it can be used in large-scale production operations, shorten labor time and save labor, reduce processing costs, better solve the problems of breaking walnut shells and taking kernels and relying hands, and improve the shell breaking rate and kernel exposing rate.

Zhang Yanbin and others invented a walnut shell and kernel drum two-way separation device with coupling of pneumatic force and flexible spiral blade. The walnut shell and kernel materials are transported from the feed hopper. The walnut shell and kernel materials are accelerated in the feed hopper and then sent to the spiral blade drum at a certain speed. The walnut shell and kernel materials enter the walnut shell and kernel separation area under the effect of wind transportation. Most of the walnut shell and kernel materials enter the walnut shell and kernel transportation area, and a few enter the walnut shell and kernel separation area. The variable pitch screw conveying vane mechanism is fixedly connected to the inner wall of the screw blade drum. The screw direction is right rotation. When the screw blade drum rotates clockwise, the screw blade plays the role of conveying walnut shell and kernel materials. The material conveying direction is from the outlet direction to the inlet direction. In the area of walnut shell and kernel separation, walnut shell and kernel materials are transported to a high place by the spiral leaf II along the circumference, and the spiral leaf II has the function of transporting walnut shell and kernel materials to the import direction; when it reaches a certain height, walnut shell and kernel materials are dropped from the air, with the initial speed to the import direction. Under the effect of wind transport, walnut kernel is transported to the walnut shell transport area by a smaller wind force; the walnut shell is transported to the walnut shell transport area by a larger wind force. In the walnut conveying area, the walnut kernel is conveyed to the exit direction of the spiral blade drum by the spiral blade III with small pitch. Due to the small pitch and small friction coefficient of the spiral blade III, a typical spiral conveying effect is formed in this area. The walnut kernel is not affected by the wind. The walnut kernel is conveyed to the exit direction of the spiral blade drum by the spiral blade III with small pitch, and then it falls into the walnut kernel collector.

To sum up, there are many existing walnut shell breaking and kernel taking technologies, which have their own advantages, but also have serious disadvantages. Some devices only pursue the function in one aspect to result in no ideal effects in other aspects, so they can not guarantee the adaptability of the shell breaking device to different sizes of walnuts, as well as the shell breaking rate and shell breaking efficiency. Then, such devices can not meet the needs and development of the market.

### SUMMARY OF PRESENT INVENTION

In order to overcome the defects of the prior art, the disclosure provides a high-efficiency automated production system for walnut shell-breaking, kernel-taking and shell-kernel separation, which can realize high-efficiency walnut shell-breaking, kernel-taking and shell-kernel separation, is fast in production speed and high in automation degree, and meanwhile can improve entire kernel rate and kernel obtaining rate, reduce the damage rate of the walnut kernel and ensure the high efficiency of breaking the shell and thoroughness of the shell and kernel separation

Further, the disclosure adopts the following technical solution:

An automated production system for efficient walnut shell-breaking, kernel-taking and shell-kernel separation, comprising a shell breaking device provided with a squeezing member to squeeze the walnut to break the shell;

a kernel vibration grading device for receiving shell and kernel mixtures after breaking the shell for vibration grading and respectively conveying to various negative-pressure shaking and sorting devices;

the negative-pressure shaking and sorting device is connected with a negative-pressure separation device which sucks and stores the shells through negative-pressure suction, and the kernels are graded and stored by the negative-pressure shaking and sorting device.

Further, the shell breaking device comprises a conveying portion for conveying walnuts to a squeezing portion and the squeezing portion comprising a squeezing roller, the lower side part of the squeezing roller is matched with a rotatable shell breaking baffle, and they both have set gaps.

Further, the shell breaking baffle is arc-shaped and bent toward the squeezing roller, and opposite sides of the shell breaking baffle and the squeezing roller are both provided with grooves.

Further, one end of the shell breaking baffle is fixed with a rack through a spindle, and the other end is connected with the rack through a spring; the rotation axis of the shell breaking baffle is parallel to that of the squeezing roller.

Further, the direction of the groove is parallel to the rotation axis of the shell breaking baffle.

Further, the outer side of the shell breaking baffle is supported by a worm, the worm is matched with a worm wheel, and the worm wheel is connected with an adjusting handle.

Further, a guide baffle is arranged above the squeezing roller, and matched with the end of the conveying portion.

Further, a grid plate is arranged above the conveying portion, and the gap between adjacent grid plates is larger than the diameter of the walnut.

Further, the kernel vibration grading device comprises a vibration base, the vibration base is fixedly provided with multiple layers of vibration screens, and the screen pores of various vibration screens are different in size; the vibration base is fixedly connected with a vibration motor.

Further, the screen pores of multiple layers of vibration screens are gradually reduced from top to bottom.

Further, the vibration motor is inclined by a set angle to be arranged, so that the multiple layers of vibration screens are vibrated in an inclined manner.

Further, the vibration screen comprises a screen, one side portion of the screen is provided with a discharging outlet, and other three side portions are fixed with steel structure frames; the screen is provided with a plurality of alternately arranged screen pores.

Further, the bottom of the vibration base is arranged on a support frame, and a spring is arranged between the support frame and the vibration base.

Further, the discharging outlet of the vibration screen on the uppermost layer is connected with an extension plate, the extension plate extends above a secondary shell breaking transfer stage, the secondary shell breaking transfer stage transfers the received materials to the shell breaking device; the discharging outlets of other layers of vibration screens are all connected with the negative-pressure shaking and sorting devices.

Further, the negative-pressure shaking and sorting device comprises a vibrostand, a secondary negative-pressure separation assembly is arranged above one side of the vibrostand, and the vibrostand is also provided with a transfer stage on this side end portion.

Further, the vibrostand comprises a vibration screen, a vibration motor is arranged at the bottom of the vibration screen, and screen pores are formed in the vibration screen corresponding to the secondary negative-pressure separation assembly.

Further, the bottom of the vibration screen is arranged on the support frame, and the spring is arranged between the support frame and the vibration screen.

Further, the height of the support frame corresponding to the secondary negative-pressure separation assembly is lower than heights at other positions.

Further, the secondary negative-pressure separation assembly comprises two negative-pressure shell sucking tables arranged in parallel, the negative-pressure shell sucking table comprises a barrel vertically arranged at the bottom and corresponding to the upper part of the vibrostand, and the top of the barrel is connected with the negative-pressure separation device.

Further, the negative-pressure separation device comprises a plurality of negative-pressure separators arranged in parallel, and the negative-pressure separators are communicated with a slagging blower through channels; the negative-pressure separators are also communicated with the negative-pressure shaking and sorting devices through pipelines, and the transfer stage is arranged under the negative-pressure separators.

Further, the negative-pressure separator comprises a negative-pressure cavity, the top of the negative-pressure cavity is provided with an opening to be communicated with the channels, and the side portion of the negative-pressure cavity is provided with an interface to be communicated with the pipeline; the bottom of the negative-pressure cavity is provided with an opening to be communicated with a drum, rotatable blades are arranged inside the drum, and the bottom of the drum is provided with an outlet.

Further, a filter plate is arranged at the opening on the top of the negative-pressure cavity.

Further, two transfer stages are arranged under the negative-pressure cavity in parallel, and the transfer directions of the two transfer stages are opposite, wherein one transfer stage is correspondingly arranged under a part of the negative-pressure separator, and the other transfer stage is correspondingly arranged under the residual negative-pressure separator.

Further, the automated production system also comprises a feeding device for feeding the shell breaking device, the feeding device comprises a storage hopper, the side portion of the storage hopper is provided with an inclined transfer belt, and conveyor baffles are arranged at two sides of the transfer belt.

Further, the automated production system also comprises the negative-pressure shaking and shell breaking device arranged between the shell breaking device and the kernel vibration grading device, the negative-pressure shaking and shell breaking device is connected with the negative-pressure separation device, the negative-pressure shaking and shell breaking device comprises the vibration screen, and a negative-pressure suction port is correspondingly arranged above the vibration screen.

Further, the vibration motor is arranged at the bottom of the vibration screen, the vibration screen is supported on the base, the spring is arranged between the base and the vibration screen, and a plurality of screen pores are formed in the vibration screen corresponding to the negative-pressure suction port.

Further, the automated production system also comprises a lift feeding device arranged between the negative-pressure shaking and shell breaking device and the kernel vibration grading device, the lift feeding device comprises the inclined transfer belt on which a conveyor baffle vertical thereto.

Compared with the prior art, the disclosure has the beneficial effects:

The automated production system of the disclosure is integrated by a plurality of systems and has perfect functions, thereby not only reducing machine manufacturing cost, but also reducing the occupied area for the machine operation, and being conducive to the miniaturization and high efficiency of the machine. The structural design can realize multiple connection and cooperation operations, such as splicing and combination, can meet the needs of various production scales and production sites, and is more widely applied.

The feeding device of the disclosure can be used for batch feeding of follow-up devices; the shell breaking device is connected with the feeding device and installed at the front end of the feeding device, so as to realize matching of the shell breaking process with the batch feeding process; meanwhile, the broken walnut shells are transported to the kernel vibration grading device under the action of the negative pressure shaking and shell breaking device and the lift feeding device, and the grading via vibration can better perform separation under different negative pressures effectively aiming at walnut shell and kernel mixtures having different entire kernel types. The negative pressure separation device is located at one side of the whole system and sucks walnut kernels through the pipeline, and a small number of walnut shells that are not completely separated are separated thoroughly by manpower through the negative pressure shaking sorting device.

The shell breaking device of the disclosure includes a conveying portion and a squeezing portion, wherein the walnuts transported by the conveying portion can be evenly distributed under the action of the grid plate fixed on the upper end thereof and its own spindle, and continuously transported to the squeezing part, thus improving the shell breaking efficiency of the overall device.

The design of the squeezing portion of the shell breaking device mainly includes a squeeze roller and a squeeze baffle. By using the rolling of the squeeze roller, the walnuts falling into the gap are squeezed and continuously rolled, thereby avoiding the phenomenon that the big walnuts are crushed to damage the walnut kernel or small walnuts cannot be squeezed and improving the efficiency of pre-breaking shell efficiency and the integrity rate of walnut kernel. At the same time, the lower end of the squeeze baffle is connected with the rack by utilizing the spring, which ensures that the squeeze baffle can restore to its original state after the shell is broken and ensuring the stability of the device. The rear end of the squeeze baffle is supported by multiple pairs of worm gears and can adjust the initial gap between the squeeze roller, and the squeeze baffle can be adjusted by rotating the worm gear in the case of different varieties of walnuts, thus improving the adaptability of the device.

The disclosure adopts a negative pressure separation device designed depending on different shell and kernel qualities. Such the system is simple and reliable, and improves the separation efficiency of shells and kernels. The slag blower is connected with the negative-pressure separator through the pipeline, and the other end of the negative-pressure separator is connected with a negative-pressure suction port through the pipeline. When the shell and kernel mixture falls on the conveyor belt of the separation device after the shell breaking device falls, the shells and debris are sucked into the negative-pressure separator from the negative-pressure suction port under the action of a negative pressure generated by the slag blower, and a filter screen is installed in a connection pipe between the negative-pressure separator and the slag blower to prevent the shell debris from being sucked into the slag blower. When a certain quantity of filtered shells are accumulated, they fall vertically into the lower end of the negative-pressure separator under the action of gravity. The lower end of the negative-pressure separator is equipped with an eccentric baffle which rotates slowly under the drive of the motor so that the shells and debris falling into the gap between the baffles are brought out from the negative-pressure separator along with the rotation of the shells and then fall into a manual picking and conveying device, and the conveying device transmits the materials to the corresponding places for packaging and storage.

### DESCRIPTION OF THE DRAWINGS

The accompanying drawings constituting one part of this application are used for provide a further understanding of the disclosure, and the illustrative embodiments of the disclosure and description thereof are used for explaining this application and do not constitute improper limitation on this application.

FIG. 1 is a diagram of an automated production line for walnut shell-breaking, kernel-taking and shell-kernel separation;

FIG. 2 is a diagram of a feeding device;

FIG. 3 is a diagram of a shell breaking device;

FIG. 4 is a diagram of an exterior of a shell breaking device;

FIG. 5 is a diagram of a negative-pressure shaking and shell-breaking device;

FIG. 6 is an exploded view of a negative-pressure shaking and shell-breaking device;

FIG. 7 is a diagram of a lift feeding device;

FIG. 8 is a diagram of a kernel vibration grading device;

FIG. 9 is an oscillation principle of a kernel vibration grading device;

FIG. 10 is an exploded view of a single-layer vibration screen;

FIG. 11 is an exploded view of a kernel vibration grading device;

FIG. 12 is a diagram of a negative-pressure shaking and sorting device;

FIG. 13 is a structural diagram of a vibrostand;

FIG. 14 is a diagram showing vibration of a vibrostand;

FIG. 15 is a diagram of a transfer stage II;

FIG. 16 is a diagram of a support frame II;

FIG. 17 is a diagram of a negative-pressure separator,

FIG. 18 is an exploded view of a negative-pressure separator,

FIG. 19 is a diagram of a secondary shell-breaking transfer stage.

In the drawings, I-feeding device, II-shell breaking device, III-lift feeding device, IV-negative-pressure separator, V-slagging blower, VI-negative-pressure shaking and sorting device, VII-kernel vibration grading device, VIII-secondary shell-breaking transfer stage, and IX-negative-pressure shaking and shell-breaking device;

I-1 based III, I-2 front baffle, I-3 storage hopper, I-4 transfer baffle, I-5 rack II, I-6 transfer belt II, I-7 support frame VII, I-8 chain wheel III I-9 shaft II, I-10 chain II, I-11 chain wheel IV, and I-12 motor III;

II-1 nut IV, II-2 worm, II-3 grid plate, II-4 bolt, II-5 spindle, II-6 motor II, II-7 rack I, II-8 chain wheel III, II-9 guide baffle, II-10 squeeze roller, II-11 shell-breaking baffle, II-12 spring III, II-13 support frame VI, II-14 worm gear, II-15 adjusting handle, II-16 chain II, and II-17 base;

III-1 conveyor baffle, III-2 conveyor belt III, III-3 rack III, III-4 chain wheel V, III-5 chain III, III-6 chain wheel VI, III-7 gear roller. III-8 bearing pedestal IV, and III-9 support frame VIII;

IV-1 transfer stage I, IV-2 turbine reducer, IV-3 large negative-pressure separator, IV-4 transfer stage II, IV-5 support frame II, IV-6 bearing I, IV-7 bearing pedestal I, IV-8 bolt IV, IV-9 drum end cover, IV-10 blade shaft, IV-11 drum, IV-12 interface II, IV-13 interface I, IV-14 bolt V, IV-15 negative-pressure cavity, IV-16 bolt VI, IV-17L type interface, IV-18 base I, IV-19 shaft I, IV-20 gear roller I, IV-21 bearing pedestal II, IV-22 conveyor belt I, IV-23 chain wheel I, IV-24 chain L, IV-25 motor I, IV-26 wheel chain II, IV-27 support frame III, IV-28 filter plate, and IV-29 small negative-pressure separator;

VI-1 vibrostand, VI-2 negative-pressure shell-sucking table, VI-3 transfer stage III, VI-4 support frame IV, VI-5 negative-pressure suction port I, VI-6 negative-pressure suction port II, VI-7 support frame V, VI-8 spring II, VI-9 vibration screen I, VI-10 vibration motor II, and VI-II base II;

VII-1 discharging outlet, VII-2 nut I, VII-3 bolt I, VII-4 bolt II, VII-5 steel structure frame, VII-6 angle iron joint, VII-7 screen, VII-8 nut II, VII-9 spring I, VII-10 nut III, VII-11 single-layer vibration screen V, VII-12 single-layer vibration screen IV, VII-13 single-layer vibration screen I, VII-14 bolt III, VII-15 single-layer vibration screen II, VII-16 single-layer vibration screen III, VII-17 vibration pedestal, VII-18 support frame I, and VII-19 vibration motor I;

VIII-1 frame IV, VIII-2 conveyor belt IV, VIII-3 motor IV, VIII-4 bearing pedestal IV, VIII-5 support frame VIII, VIII-6 base III, VIII-7 chain wheel VII, VIII-8 chain IV, and VIII-9 chain wheel VIII;

IX-1 base IV, IX-2 spring IV, IX-3 vibration screen II, IX-4 bolt VII, IX-5 negative-pressure suction port III, IX-6 support frame VI, IX-7 outlet, IX-8 bolt VIII, and IX-9 vibration motor III.

### DETAILED DESCRIPTION OF PREFERRED EMBODIMENTS

It should be noted that the following detailed description are all illustrative and intended to provide further description on this application. Unless stated otherwise, all technical and scientific terms have the same meaning as those understood by ordinary skill in the art.

It is noted that, terms used herein are only for describing embodiments but are not intended to limit illustrative embodiments according to this application. As used herein, unless explicitly indicated otherwise, singular forms are intended to include plural forms. In addition, it also should be understood that when the term “comprise” and/or “include”, it indicates the existing features, steps, operations, devices, assemblies and/or their combinations.

Just as discussed in the background, the prior art has the disadvantages that the current system cannot matched with walnuts having different sizes and shell breaking rate and shell breaking efficiency cannot be ensured. In order to solve the above technical problem, this application provides a high-efficiency automated production system for walnut shell-breaking, kernel-taking and shell-kernel separation. The system of the disclosure uses the conveyor belt to replace manual feeding, which can realize the precise feeding and improve the efficiency. The adjustment function is realized by using a fact that the different sizes of walnuts falling into the gaps make the spring have inconsistent tightness, so as to reduce the walnut grading process and improve the adaptability of the machine; a multi-layer vibration screen with different gaps is designed by making full use of a feature that kernels have different shapes and sizes, and the kernels can be stably and efficiently graded through the vibration screening of the multi-layer vibration screen, and the vibration screen on each layer can be conveniently disassembled and exchanged, and can be adapted to materials having different sizes; the negative pressure separation device is designed by utilizing different proportions of kernels and shells, and the shells in the shell and kernel mixture are efficiently sucked through the negative pressure suction provided by the slag blower, and multiple negative-pressure suction ports are designed to suck shells of materials at negative pressure many times, thereby thoroughly separating the shells from kernels.

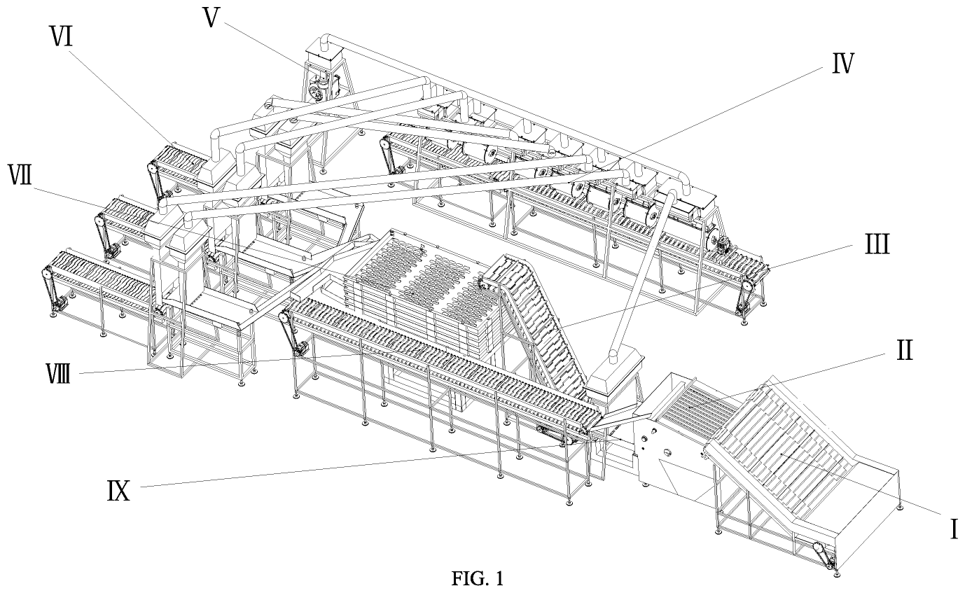

As shown in FIG. 1, a typical embodiment of this application provides an automated production system for efficient walnut shell-breaking, kernel-taking and shell-kernel separation. FIG. 1 is an integral diagram according to the disclosure. It can be seen from FIG. 1 that this system has eight devices, respectively including a feeding device I, a shell breaking device II, a lift feeding device III, a negative-pressure separation device IV, a negative-pressure shaking and sorting device VI, a kernel vibration grading device VII, a secondary shell breaking conveyor stage VIII, a negative-pressure shaking and shell-breaking device IX. The feeding device I provides batch feeding for a shell breaking device II. The shell breaking device II includes a squeezing portion and a conveying portion which are matched with each other. The conveying portion feeds walnuts to the squeezing portion through a rolling conveyor belt driven by a chain. The squeezing portion is matched with the angle-adjustable baffle through the continuous rolling drum so that falling walnuts are broken, the negative pressure shaking and shell breaking device IX screens out the tiny broken shells and then feeds the broken walnuts into the kernel vibration grading device VII, the kernel vibration grading device VII are divided into four layers according to pore sizes, the shells of the graded walnuts are first sucked away by the negative pressure separation device IV, and then enter the negative pressure shaking sorting device VI. The remaining walnut shells are picked manually in the negative-pressure shaking and sorting device VI, where the largest-grade walnuts are conveyed again to the shell breaking device II through the secondary shell breaking conveyor stage VIII for secondary breaking.

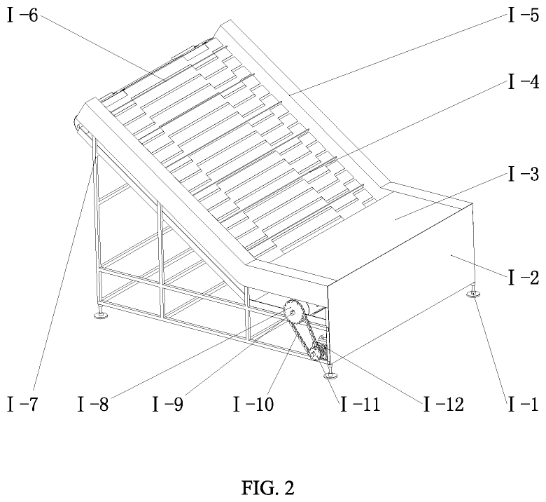

As shown in FIG. 2, FIG. 2 is a diagram of a feeding device according to the disclosure. The feeding device I includes a conveyor belt II I-6, the conveyor baffle I-4 is fixed on the conveyor belt II I-6, the storage hopper I-3 is tightly matched with the rear end of the conveyor belt II I-6, the front end of the conveyor belt II I-6 is matched with the shell breaking device II. The motor III drives the chain wheel to circularly move the conveyor belt II I-6, so as to drive the walnuts in the storage hopper I-3 to upwardly move under the pushing of the conveyor baffle I-4, thereby achieving continuous feeding.

It can be seen from FIG. 2 that the support frame VII I-7, the base III-1 and the rack II I-5 are connected through bolts to form the overall frame of the device. The motor III I-12 is fixed on the support frame VII I-7 through bolts, the chain wheel IV I-11 is connected with the output shaft of the motor III I-12 through keys, and the chain wheel III I-8 is connected with the chain wheel IV I-II through the chain II I-10, and the chain wheel III I-8 is fixed on the shaft II I-9 through keys, so that the motor III I-12 can transfer the power to the shaft II I-9. The front baffle plate I-2 and the storage hopper I-3 are fixed on the support frame VII I-7 through bolts to form the storage hopper of the device. The conveyor baffle I-4 is fixed on the conveyor belt II I-6 through small screws, and the conveyor belt II I-6 is driven by the shaft II I-9. Finally, a function of upwardly transporting the walnuts to the next device is completed.

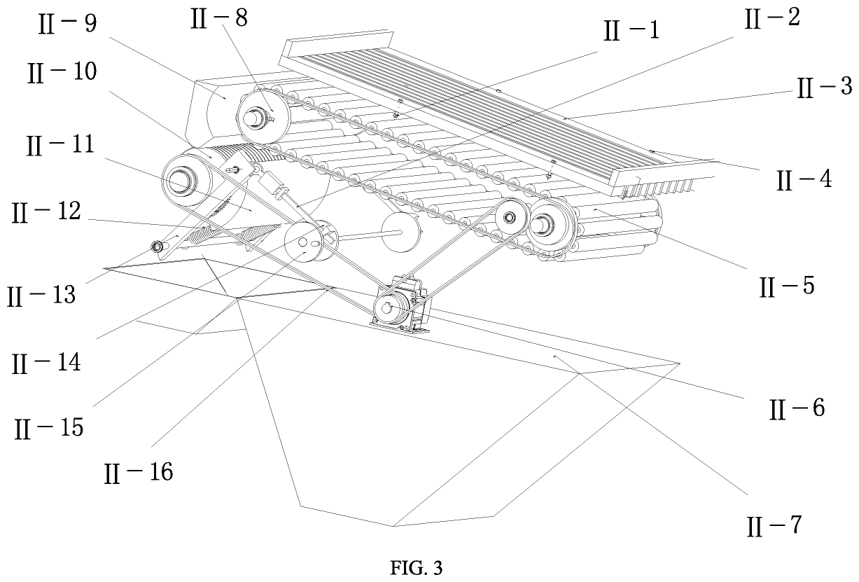

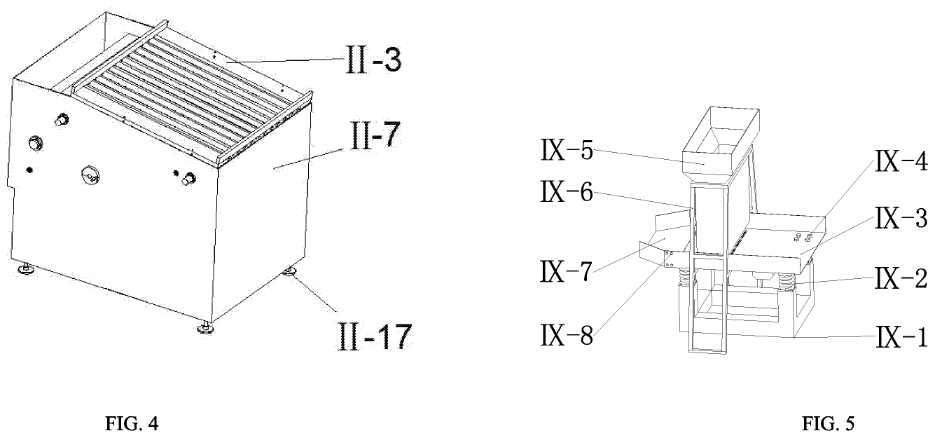

As shown in FIGS. 3-4, FIGS. 3-4 are diagrams of the shell breaking device according to the disclosure. The shell breaking device II includes the conveying portion and the squeezing portion. The conveying portion is fixed on the spindle II-5 of the chain. The upper end of the conveying portion is fixed with the grid plate II-3. The gap between the grid plates II-3 is larger than the maximum diameter of the walnut and there is a certain distance between grid plates II-3 and the spindle II-5. The spindle II-5 can rotate freely. After falling into the conveying portion, the walnuts can be regularly distributed under the action of the spindle II-5 and the grid plate II-3. The squeezing portion is a combination of the squeezing roller II-10 and the shell breaking baffle II-11, and the upper end of the squeezing roller II-10 is fixed with the guide baffle II-9 which can guide the walnuts conveyed by the conveying portion to the gap between the squeezing roller II-10 and the shell breaking baffle II-11. The material of the squeezing roller II-10 is hard rubber, and grooves are formed on the squeezing roller II-10. The axial length of the groove is larger than the long diameter of the walnut, and the radial length of the groove is matched with the installation distance between the squeezing roller 1I-10 and the shell breaking baffle II-11. The rotation axis of shell breaking baffle II-11 is parallel to the squeezing roller II-10. Both ends of the rotation axis of the shell breaking baffle II-1 are fixed on the corresponding bearing pedestals through bearings, and two bearing pedestals are fixed on the rack. The lower end of the shell breaking baffle II-11 is connected with the rack through springs to ensure that the gap between the squeezing roller and the squeezing baffle can change when the walnut shells having different sizes are broken and can be restored after being enlarged. The rear side of the shell breaking baffle II-11 is supported by the worm I-2, the worm II-2 is connected with the worm gear II-14, and the worm II-14 is coaxially connected with the adjusting handle II-15 outside the rack. The expanding spiral angle β of the worm is smaller than the contact friction angle Φ of the worm and the worm gear, so as to meet self-locking conditions. The shell breaking baffle II-11 has a groove, and the groove direction is parallel to the rotation axis of the shell breaking baffle II-11, so that friction is increased when breaking the walnut shells are broken.

The squeezing roller II-10 is directly connected with the driving mechanism through the chain, the chain wheel at the rear end of the conveying portion is meshed with another gear through a gear coaxial to the chain wheel for direction change, another gear is connected with the driving mechanism through chains by virtue of the chain wheel coaxial to the another gear. The shafts are fixed on the support frame through bearings, the support frame is fixed on the rack I II-7. The bottom of the rack I II-7 is fixed on the base II-17.

It can be seen from FIGS. 3-4 that the grid plate II-3 is fixed on the rack I II-7 through the bolt II-4 and the nut IVII-1, the spindle II-5 is connected with the chain through the thin shaft fixed between the two chains and can rotate around the thin shaft, and the chain is driven by the chain wheel III II-8. Since the steering of the chain wheel II-8 is opposite to that of the motor II-6, a pair of meshed gears are used to change the direction. The guide baffle plate II-9 is connected with the rack I II-7 through the bolts to guide the walnuts to the squeezing portion. The squeezing roller II-10 rotates through the bearing seat II fixed on the rack I II-7, and forms the squeezing portion with the shell breaking baffle II-11, wherein the shell breaking baffle II-11 is supported by the support frame VIII-13, and the lower end of the shell breaking baffle II-11 is connected with the rack I II-7 through the spring III II-12, the rear end of the shell breaking baffle II-11 is hinged with the worm II-2 through the bearing, the worm II-2 is connected with the worm gear II-14, and the worm gear II-14 is coaxially connected with the adjusting handle II-15, the opening and closing angle of the shell breaking baffle II-11 can be adjusted by the adjusting handle II-15. The power of the squeezing roller II-10 is transmitted by the chain wheel fixed thereon through the connection between the chain II-16 and the motor II-6. Finally, it can be ensured that the walnuts with different diameters can be automatically adjusted to different opening and closing angles to meet the requirements with high production efficiency.

The working principle of the shell breaking device is as follows:

The walnuts enter the shell breaking device from the feeding device to be regularly distributed under the action of the spindle of the conveyor portion and the grid plate, and then enter into the gap between the squeezing roller and the shell breaking baffle in rows under the action of the guide baffle fixed at the upper end of the squeezing roller, wherein the lower end of the shell breaking baffle is connected with the rack through a spring to ensure that the gap between the squeezing roller and the shell breaking baffle can change and recover after change when the walnut shells having different sizes are broken, and the rear side of the shell breaking baffle is supported by the worm, the worm is connected with the worm gear, and the worm gear is coaxially connected with the adjusting handle outside the rack, and the size of the initial gap can be adjusted by the adjusting handle. Finally, the walnuts falling into the gaps generate cracks through the squeezing of the squeezing roller and rolling on the shell breaking baffle so as to finally realize the shell breaking.

As shown in FIG. 5, FIG. 5 is a diagram of a negative-pressure shaking and shell breaking device according to the disclosure. The negative-pressure shaking and shell breaking device is mainly composed of the vibration screen IIIX-3, the support frame IXIX-6, the base IVIX-1, the negative-pressure suction port IIIIX-5, the spring IVIX-2, the vibration motor IIIIX-9 and the outlet IX-7. The main function of the negative pressure shaking and shell removing device is to remove the shell from the mixture of shells and kernels by vibration and negative pressure suction, thereby achieving first shell and kernel separation.

The negative-pressure suction port III IX-5 is fixed on the support frame IX IX-6 through bolts, the support frame IX IX-6 plays a role in supporting the negative-pressure suction port III IX-5, and the negative-pressure suction port III IX-5 is installed at the upper end of the material. When the material passes through the lower end of the negative-pressure suction port III IX-5, the shells in the material can be sucked out.

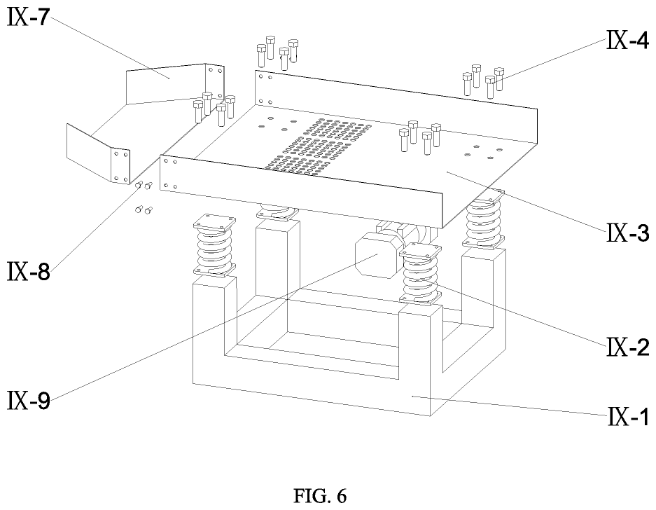

As shown in FIG. 6, FIG. 6 is an exploded view of a negative-pressure shaking and shell breaking device according to the disclosure. The base IVIX-1 plays roles of supporting and fixing and is a rectangular support, and the spring IV IX-2 is installed on four support feet protruding from the upper end of the base IV IX-1. The other end of the spring IV IX-2 is installed at the bottom of the vibration screen II IX-3 through the bolt VII IX-4. Four springs jointly support the vibration screen, and can support the vibration of the vibration screen II IX-3. The vibration motor III IX-9 is installed at the bottom of the vibration screen II IX-3 and connected and fixed through the bolts, and can drive the vibration screen II IX-3 to perform up and down reciprocating vibration to achieve shaking. The side of the vibration screen II IX-3 is connected with outlet IX-7 through the bolts VIIIVIII IX-8, and the materials enter the next processing procedure through the outlet IX-7.

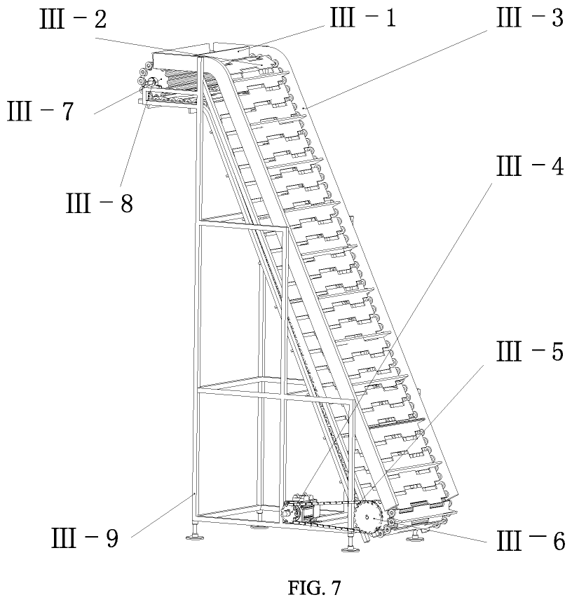

As shown in FIG. 7, FIG. 7 is a diagram of a lift feeding device according to the disclosure. It can be seen from FIG. 7 that the conveyor baffle III-1 is fixed on the conveyor belt III III-2 by small screws, and the conveyor belt II-2 is arranged on the rack III III-3. The conveyor belt III III-2 is driven by the chain wheel VIII-4 and the chain wheel VI III-6, wherein the chain wheel is fixed on the gear roller III-7, and the gear roller III-7 is fixed on the support frame VIIIVIII III-9 through the bearing pedestal IV III-8. The front end of the conveyor belt 111 III-2 is matched with the kernel vibration grading device. The power of transmission drives the chain III III-5 by the motor through the chain wheel V III-4 fixed on the motor, and then drives the chain wheel VI III-6 to rotate. The chain wheel VI III-6 is connected with a transmission shaft through keys, so the power can be transmitted to the transmission shaft to drive the conveyor belt to circularly rotate, so as to drive the shell-broken walnuts in the storage hopper to upwardly move under the pushing of the transmission baffle, thereby realizing continuous transmission to convey the walnuts to the next device.

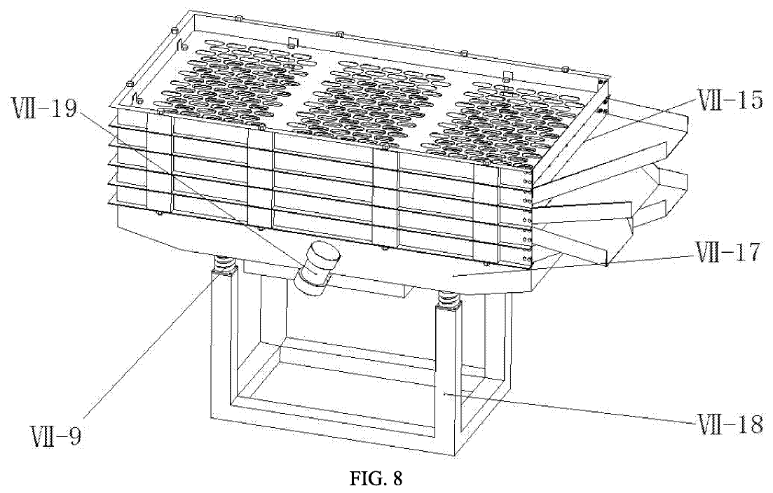

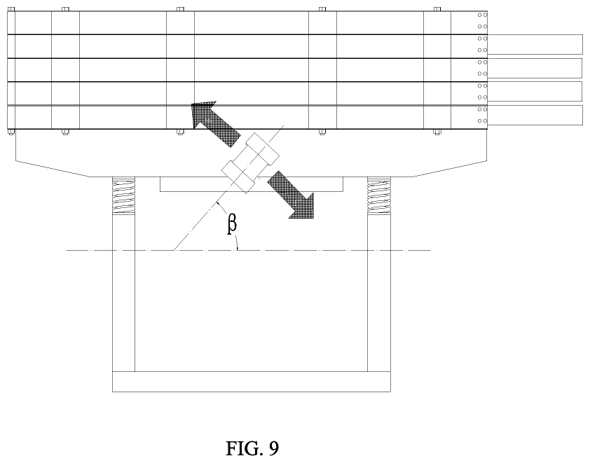

As shown in FIGS. 8 and 9, FIGS. 8 and 9 are diagrams of the kernel vibration grading device VII according to the disclosure. The kernel vibration grading device consists of a five-layer screen, a vibration base VII-17 and a vibration motor I VII-19. The gaps between the meshes of each layer of vibration screen are different, and from large to small, respectively can separate incomplete shell-broken kernels, half kernels, quarter kernels and shell-broken kernels. The vibration screens are successively installed on the vibration base from top to bottom according to the sizes of the gaps between screen pores. The installation sequence is that a screen having large gaps is on the top, and the screen gap size is reduced in turn. Such the installation achieves screening and filtration of walnuts one by one by virtue of five layers of vibration screens, so that kernels having corresponding sizes can be kept in the corresponding layers of the screens to achieve the separation of different kernels.

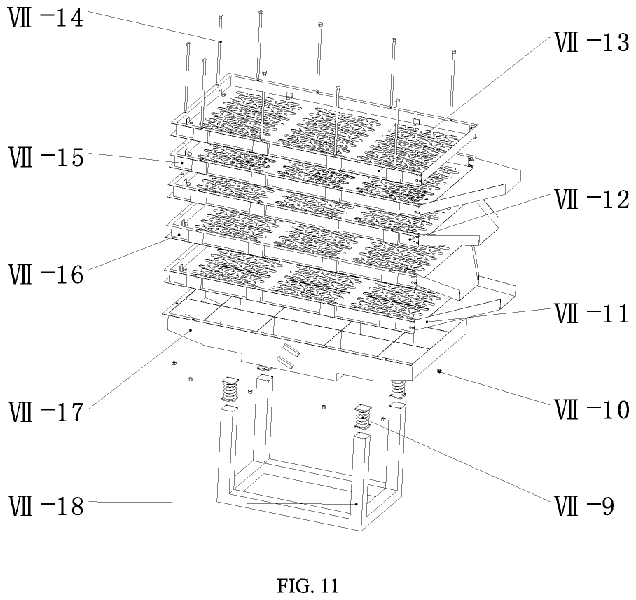

It can be seen from FIG. 11 that through the bolt III VII-14 and the nut III VII-10, the single-layer vibration screen I VII-13, the single-layer vibration screen II VII-15, the single-layer vibration screen III VII-16, the single-layer vibration screen IV VII-12 and the single-layer vibration screen V VII-1 are successively fixed on the vibration base VII-17, two vibration motors VII-19 are symmetrically installed at both sides of the vibration base through bolts, and the simultaneous working of the two motors can drive the five layers of vibration screens to do reciprocating vibration. At the same time, four corners at the bottom of the vibration base VII-17 are connected to the square support frame I VII-18 by the springs I VII-9, and the support frame I VII-18 is placed on the bottom surface to play a role in supporting the whole device. There are two through bolt holes in both sides and the rear of each layer of the vibration screen to be in one-to-one correspondence to the bolt holes in the corresponding positions of the vibration base. The extension bolt III VII-14 passes through the five layers of vibration screens and the vibration base in turn, and are locked and connected by the self-locking nuts III VII-10. In order to prevent the relative displacement of each layer of vibration screen, four corners on each layer of contact surface are connected and reinforced by bolts after the five layers of vibration screens are positioned and clamped.

The height difference L between the front and rear legs of the support frame I VII-18 can allow the vibration base and the four layers of vibration screens to be tilted forward at a certain angle so as to be installed. Therefore, during the vibration process, the kernels separated from each layer can be discharged from the front discharging outlet VII-1 of each layer of vibration screen and enter a sorting device for corresponding kernel sizes to be sorted. Two vibration motors I VII-19 are installed at an angle β with the horizontal ground. As the two motors are symmetrically installed, when the vibration motors at both sides simultaneously work, the vibration in the horizontal plane can be canceled to each other, reciprocating movement is done along the normal direction of the β angle in the vertical plane, as shown in FIG. 9. Under the action of vibration, different kernels pass through five layers of vibration screens one by one, and are stored in the single-layer vibration screen having appropriate size, and discharged from the corresponding discharging outlet with the vibration of the vibration screen, thereby realizing vibration grading. The four corners on the bottom surface of the vibration base VII-17 are fixed with four identical springs VII-9 through bolts. The lower ends of the springs VII-9 are fixed on the support frame VII-18 to play a role in supporting the whole device. The heights of two pairs of support columns at front and rear ends of the support frame VII-18 are slightly different. The rear end is slightly higher than the front end so that the whole device is inclined backwardly by the angle α so as to facilitate the stacking and unloading of materials at the rear end of the device.

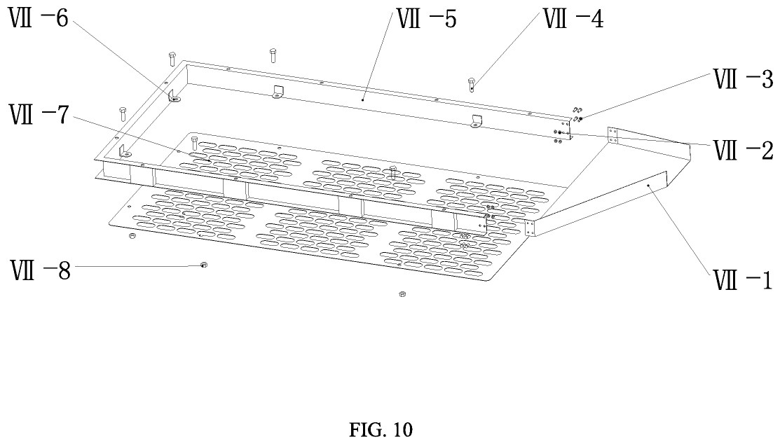

The specific structure and installation mode of the single-layer vibration screen II VII-15 are shown in FIG. 10: the single-layer vibration screen II VII-15 is composed of a steel structure frame VII-5, a screen VII-7 and a discharging outlet VII-1. The steel structure frame VII-5 is a rectangular frame with an opening on one face, and has a height of about 16 cm. Bolt holes are left at both sides and at the rear end to connect each vibration screen through the bolt II VII-4 and the nut II VII-8. At the same time, square pipes are welded around each bolt hole to play a role in supporting. The angle iron joint VII-6 is welded inside the steel structure frame VII-5 to connect the screen VII-7. The screen VII-7 is a sheet steel plate on which gaps having the same size and staggered are punched, and bolt holes are punched at four sides to connect with the steel structure frame VII-5. Bolt holes are reserved at the opening side of the steel structure frame VII-5 to be connected with the discharging outlet VII-1 by the nuts I VII-2 and the bolts I VII-3. The discharging outlet VII-1 is a trapezoid box with openings at both ends, and is surrounded by iron sheets. Materials enter from the large end and slide out of the small end, which plays a role in guiding. Bolt holes are reserved at the large end of the discharging outlet VII-1 to connect with the steel structure frame VII-5.

The discharging outlet VII-1 of the vibration screen on the top is connected with the extension plate, and the extension plate extends above the secondary shell breaking conveyor stage VIIIVIII. The secondary shell breaking by bolts VIIIVIII transmits the received materials to the shell breaking device II for secondary shell breaking of the walnuts without completely broken shells. The discharging outlets VII-1 of the other layers of vibration screens are all connected with the negative-pressure shaking and sorting device VI which is independent from negative-pressure shaking and sorting devices VI connected with vibration screens on different layers to respectively store the graded walnuts.

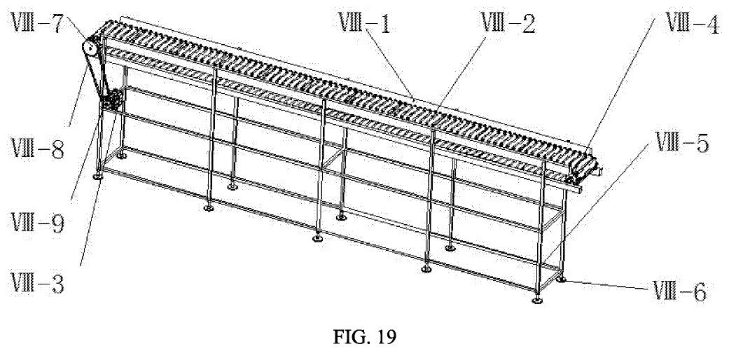

The secondary shell breaking conveyor stage VIIIVIII is shown in FIG. 19, including a frame IV VIIIVIII-1, a conveyor belt IV VIIIVIII-2, a motor IV VIIIVIII-3, a bearing pedestal IV VIIIVIII-4, a support frame VIIIVIII VIIIVIII-5, a base III VIIIVIII-6, a chain wheel VII VIIIVIII-7, a chain IV VIIIVIII-8 and a chain wheel VIIIVIII-9, the conveyor belt IV VIIIVIII-2 is installed on the frame IV VIIIVIII-1, the support frame VIIIVIII-5 is installed on the base HI VIIIVIII-6, and both ends of the support frame VIIIVIII-5 are fixed respectively with two pairs of bearing pedestals IV VIIIVIII-4, and front and rear sections of the support frame VIIIVIII-5 have the same structure. The bearing pedestal IV VIIIVIII-4 at the rear end thereof is equipped with the chain wheel VII VIIIVIII-7 which is connected with the chain wheel VIIIVIII VIIIVIII-9 through the chain IV VIIIVIII-8. The chain wheel VIIIVIII-9 rotates slowly under the drive of the motor IV VIIIVIII-3, thereby driving the conveyor belt IV VIIIVIII-2 to move so as to realize transportation of materials.

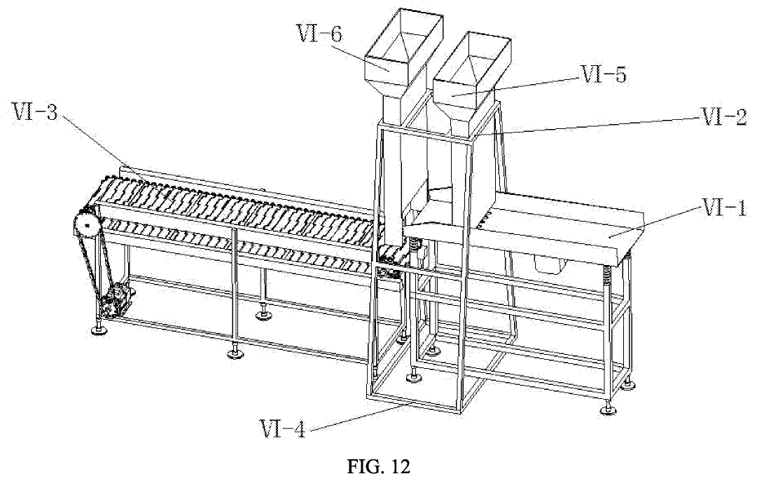

As shown in FIGS. 12, 13 and 14, FIGS. 12, 13 and 14 are diagrams of a negative-pressure shaking and sorting device VI according to the disclosure. It can be seen from FIG. 12 that the device is mainly composed of a vibrostand VI-1, a negative pressure shell suction table VI-2 and a conveyor stage III VI-3. The mechanism of the conveyor stage III VI-3 is the same as that of the conveyor stage II IV-4. The structure of the negative pressure shell suction table VI-2 is shown in FIG. 12, which is mainly composed of the support frame IVVI-4, the negative-pressure suction port I VI-5 and the negative-pressure suction port II VI-6. The upper part of the front end of the vibration screen VI-9 is installed with the negative-pressure suction port I VI-5 and the negative-pressure suction port II VI-6 in parallel. The support frame IV VI-4 is a welded steel structure support, which plays a role in supporting. The negative-pressure suction port I VI-5 and the negative-pressure suction port II VI-6 are connected and fixed on the support frame IV VI-4 through the bolts. The functions of the negative-pressure suction port I VI-5 and the negative-pressure suction port II VI-6 are to suck the shells and debris remained in the graded kernels, and to obtain cleaner and more complete kernels. The negative-pressure suction port I VI-5 and the negative-pressure suction port II VI-6 respectively perform twice negative pressure shell sucking treatment on the kernels, which can more thoroughly separate the shells from the debris.

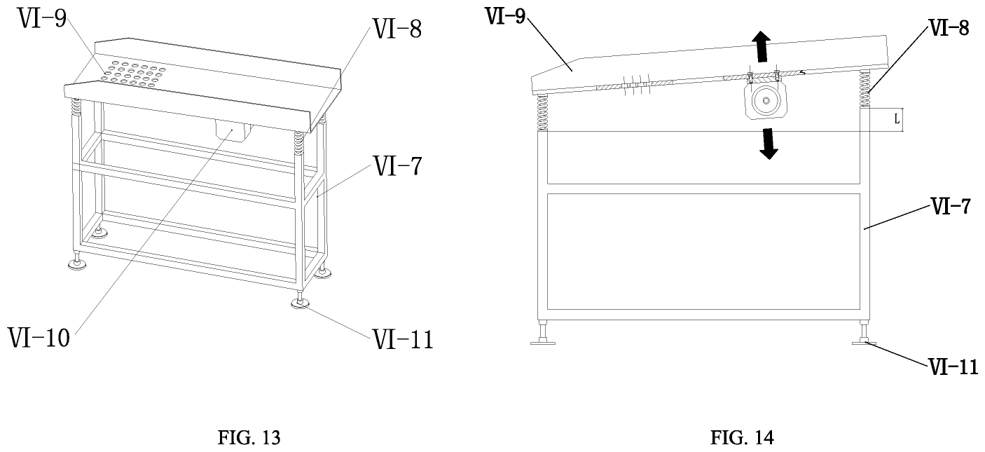

The structure of the vibrostand VI-1 is shown in FIG. 13, and the vibrostand VI-1 mainly consists of the support frame V VI-7, the spring II VI-8, the vibration screen VI-9, the vibration motor II VI-10 and the base II VI-11. The graded kernels are conveyed to the bottoms of the negative-pressure suction port I VI-5 and the negative-pressure suction port II VI-6 through the vibration effect, the shells and the debris in the graded kernels are effectively removed through self vibration coordinated with the suction from the negative-pressure suction port I VI-5 and the negative-pressure suction port I VI-6. The support frame V VI-7 takes effects of supporting and fixing, the four corners at the bottom of the support frame are equipped with the base II VI-11, the base II VI-11 is disposed on the ground, four springs II VI-8 are installed on four support legs extending from the top of the support frame, the base is of a rectangular shape and the lengths of two pairs of front support legs are different, the heights of two pairs of rear support legs are shorter than those of two pairs of front support legs by L, in such a way, the vibration screen VI-9 installed on the sprig II VI-8 is backwardly inclined by an angle to facilitate the shaking of the materials. The other ends of the springs II VI-8 are connected and fixed on four corners at the bottom of the vibration screen VI-9. The specific structure of the vibration screen VI-9 is as shown in FIG. 13 and is of a rectangular box shape with openings at two ends and on the top. The vibration screen VI-9 is surrounded by iron plates and small pores are punched at a position corresponding to the negative-pressure suction port I VI-5 at the rear end thereof to take effects of screening slag and sucking air at negative pressure. The vibration motor II VI-10 is installed at the bottom of the vibration screen VI-9 and is connected and fixed by bolts. After the motor is started, it will drive the whole vibration screen VI-9 to vibrate back and forth in the direction shown in FIG. 14. Driven by the vibration motor, the kernels are continuously gathered in the middle of the vibration screen. Small meshes are present in the middle of the vibration screen, fine kernels and shell debris are shaken out from the gaps of the meshes under the action of vibration so as to take the effect of slagging.

The conveyor stage III VI-3 is composed of the conveyor belt, the roller, the motor and the support frame. The conveyor belt sleeved with the rollers at both ends is fixed at both ends of the support frame through the bearing pedestal on the support frame. The motor drives the roller to rotate through the chain wheel, so as to drive the conveyor belt to forwardly convey the materials.

The working principle of the negative-pressure shaking and sorting device is as follows:

The walnut kernels treated by the vibration grading device first fall into the vibrostand which vibrates back and forth under the driving of the vibration motor. At the same time, small mesh pores are present under the vibrating screen, which can filter the broken kernels and shells in the vibration process of walnut kernels. The remaining walnut kernels slide into the inclined lower end of the vibration screen under the action of vibration, and two negative-pressure suction ports with different suctions are formed above the vibration screen. The purpose is to perform secondary negative-pressure separation on the filtered kernels to suck the shell mixture remaining in the kernels. Two negative-pressure suction ports are installed on the upper part of the vibration screen in parallel, and the suction of the second suction port is slightly less than that of the first suction port, so this design can effectively suck the small shells in the kernel mixture, with good effect and simple structure. The separated kernels will fall into the conveyor stage. In the process of conveying, workers at both ends of the conveyor stage can manually sort and pack the kernels, and meanwhile, the kernels can be sent to the designated storage unit for storage through the conveyor stage.

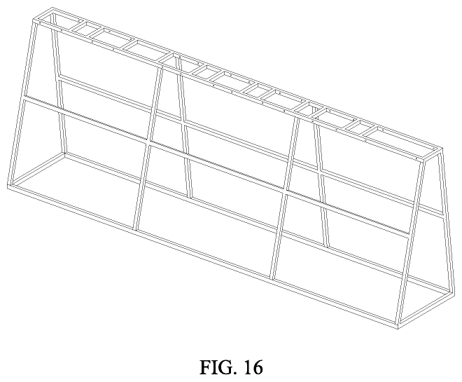

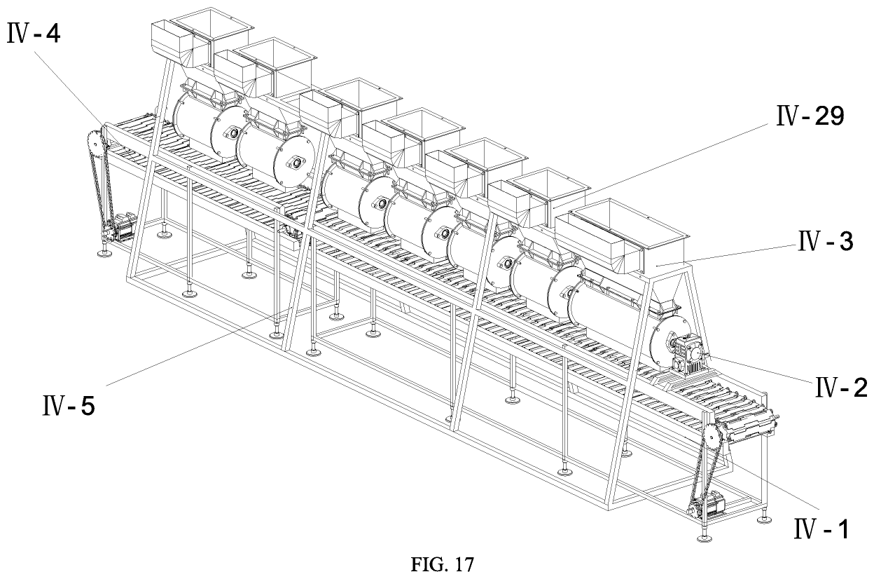

As shown in FIG. 17, FIG. 17 is a diagram of a negative-pressure separation device IV according to the disclosure. It can be seen from FIG. 17 that the device is mainly composed of a large negative-pressure separator IV-3, a small negative-pressure separator IV-29, a conveyor stage I IV-1, a conveyor stage II IV-4, a worm gear reducer IV-2, a support frame II IV-5 and a slagging blower V. The slagging blower V is an independent entirety, and placed beside a production line to provide a negative-pressure power for the whole production line. The slagging blower V is connected with the large negative-pressure separator IV-3 and the small negative-pressure separator IV-29 through pipelines; connection outlets of all the pipelines are sealed and fixedly connected by bolts. The large negative-pressure separator IV-3 and the small negative-pressure separator IV-29 are the core parts of the whole negative-pressure separation device, which are installed on the support frame IV-5 side by side. One large negative-pressure separator IV-3 and six small negative-pressure separators IV-29 are installed in the negative-pressure separation device, and have completely same other structures except that lateral dimensions are slightly different. One large negative-pressure separator IV-3 is mainly responsible for sucking and separating the shells in the mixture just after breaking the shells. The number of shells is large, so the lateral dimension is slightly larger. The six small negative-pressure separators IV-29 are mainly responsible for sucking and separating the residual shells in the kernels after vibration grading. The number of shells is small, so the lateral dimension is slightly smaller. The seven negative-pressure separators are all directly driven by the worm and worm gear reduction motor IV-2 and work at the same time. Moreover, the seven negative-pressure separators are all fixed on the support frame II IV-5 by bolt groups, and the structure of the support frame II IV-5 is shown in FIG. 16. In addition, the lower ends of the seven negative-pressure separators are provided with the conveyor stage I IV-1 and the conveyor stage II IV-4. The shells separated by the seven negative-pressure separators can fall on the conveyor belts of the conveyor I IV-1 and the conveyor stage II IV-4. The operation directions of the two conveyor stages are opposite to facilitate collection and subpackage of shells having different sizes. When the device is working, the shells and debris are sucked into the negative-pressure separator from the negative-pressure suction port under the negative pressure generated by the slag blower, and a filter screen is installed in the connection pipe between the negative-pressure separator and the slagging blower, which can prevent the shell debris from being sucked into the slagging blower. When a number of filtered shells are accumulated, they can fall vertically into the lower end of the negative-pressure separator under the action of gravity. An eccentric blade is installed at the lower end of the negative-pressure separator, and the blade rotates slowly under the drive of the motor, so that the shells and debris falling into the blade gap are brought out of the negative-pressure separator along with the rotation of the shell, and then fall into the manual picking conveyor stage, and then the conveyor stage conveys the materials to the corresponding places for packaging and storage.

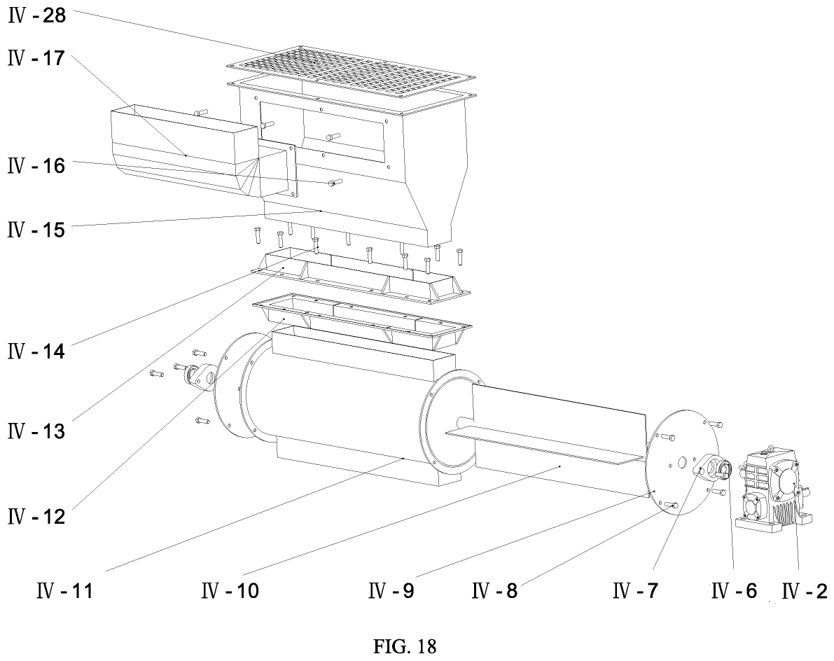

As shown in FIG. 18, FIG. 18 is a diagram of a large negative-pressure separator IV-3 according to the disclosure. It can be seen from FIG. 18 that the device is mainly composed of the drum IV-11, the drum end cover IV-9, the blade shaft IV-10, the interface II IV-12, the interface I IV-13, the negative-pressure cavity IV-15, the L-type interface IV-17 and the filter plate IV-28. The drum IV-11 is a cylinder with two openings on the bottom surface and is surrounded by iron sheets. Both sides of the cylinder are opened for respectively feeding and blanking. The drum end cover IV-9 is fixed at both ends of the drum IV-11 through the bolt IV-8, and the bearing pedestal I IV-7 is respectively fixed outside the two drum end covers IV-9 through bolt connection. The bearing I IV-6 is clamped in the bearing pedestal I IV-7 to support the blade shaft IV-10, and the blade shaft IV-10 penetrates into the drum IV-11, and a plurality of blades are arranged on the blade shaft IV-10, and the blade shaft IV-10 slowly rotates under the drive of the worm and worm gear motor IV-2 so as to take an effect of separating shells. The interface II IV-12 is welded on the upper end of the drum IV-11, and is connected with the interface I IV-13 through the bolt V IV-14. The interface I IV-13 is welded with the lower end of the negative-pressure cavity IV-15. The L-type interface IV-17 is connected to the side of the negative-pressure cavity IV-15 through the bolt VI IV-16, the top of the L-type interface IV-17 of the large negative-pressure separator IV-3 is connected with the negative-pressure suction port III IX-5 of the negative pressure shaking and shell removing device through the pipeline, and the top of the L-type interface IV-17 of the small negative-pressure separator IV-29 is connected with the negative-pressure suction port I VI-5 and the negative-pressure suction port II VI-6 of each negative-pressure shaking and sorting device through the pipeline. The upper end of the negative-pressure cavity IV-15 is connected with one pipe interface of the slag blower V, and a layer of filter plate I V-28 is sandwiched between the upper end of the negative-pressure cavity IV-15 and the pipe interface to play the role of filtering the shells. The front end of the negative-pressure cavity IV-15 is connected with the corresponding negative-pressure suction port through the pipeline to suck the shells.

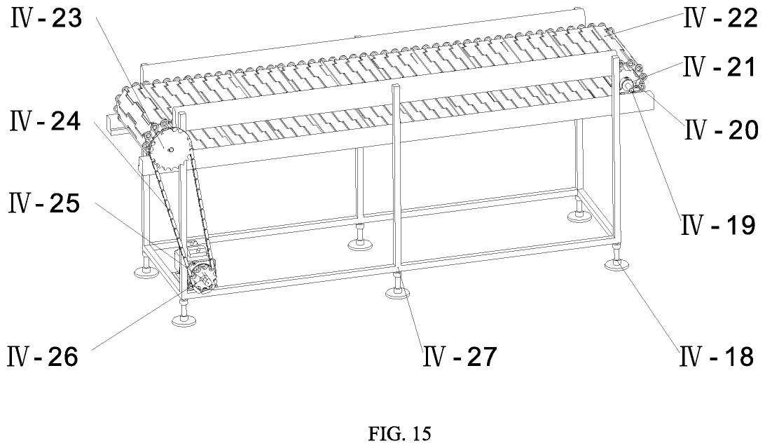

As shown in FIG. 15, FIG. 15 is a diagram of a conveyor stage II IV-4 according to the disclosure. It can be seen from FIG. 15 that the device is mainly composed of a support frame III IV-27, a motor I IV-25, a gear I IV-23, a gear II IV-26, a chain I IV-24, a conveyor belt I IV-22, a gear roller I IV-20 and a base I IV-18. The support frame III IV-27 is installed on the base I IV-18, two pairs of front and rear bearing pedestals III IV-21 with their own bearings are fixed at both ends of the support frame III IV-27, the shafts I IV-19 are installed on the two pairs of front rear bearing pedestals II IV-21, the gear roller I IV-20 is sleeved on the shaft I IV-19, and the synchronous tooth shape thereon can drive the movement of the conveyor belt I IV-22. The front and rear sections of the support frame III IV-27 have the entirely same structure. The shaft corresponding to the shaft I IV-19 of the rear end of the support frame III IV-27 is equipped with gear I IV-23 which is connected with the gear II IV-26 through the chain I IV-24. The gear IT IV-26 rotates slowly under the drive of the motor I IV-25, so as to drive the movement of the conveyor belt I IV-22 to realize the transportation of materials.

The working principle of the negative-pressure separation device is as follows:

The mixture of walnut shells and kernels after breaking the shells falls into the negative-pressure suction port. Because the slagging blower keeps rotating, the negative pressure is generated in the pipeline, which allows the negative-pressure suction port to have suction. Meanwhile, because the masses of walnut shells and kernels are different, the shells and debris under the negative-pressure suction port can be sucked into the negative-pressure separator from the negative-pressure suction port under the negative pressure generated by the slagging blower. A filter screen is installed in the connection pipe between the negative-pressure separator and the slagging blower to prevent the shells and debris from being sucked into the slag blower. When a certain number of filtered shells are accumulated, they will fall vertically into the lower end of the negative-pressure separator under the action of gravity. At the same time, an eccentric blade is installed at the lower end of the negative-pressure separator, and the blade rotates slowly under the drive of the motor, so that the shells and debris falling into the blade gap are brought out from the negative-pressure separator along with the rotation of the shells, and fall into the manual picking conveyor stage, and the conveyor stage can convey the materials to the corresponding places for packaging and storage.

The above descriptions are only preferred embodiments of this application but not intended to limit this application. For those skilled in the art, various changes and improvements can be made to this application. Any modification, equivalent replacement, improvement and the like made within the spirit and principles of this application shall be included in the scope of protection of this application.

We claim:

1. A high-efficiency automated production system for walnut shell-breaking, kernel-taking and shell-kernel separation, comprising a shell breaking device provided with a squeezing member to squeeze the walnut to break the shell;
a kernel vibration grading device for receiving shell and kernel mixtures after breaking the shell for vibration grading and then respectively conveying to various negative-pressure shaking and sorting devices;
the negative-pressure shaking and sorting device is connected with a negative-pressure separation device, the negative-pressure separation device sucks and stores the shells through negative-pressure suction, and the kernels are classified and stored by the negative-pressure shaking and sorting devices.

2. The automated production system according to claim 1, wherein the shell breaking device comprises a conveying portion for conveying walnuts to a squeezing portion and the squeezing portion comprising a squeezing roller, the lower side part of the squeezing roller is matched with a rotatable shell breaking baffle, and both have set gaps.

3. The automated production system according to claim 2, wherein the shell breaking baffle is arc-shaped and bent toward the squeezing roller, and opposite sides of the shell breaking baffle and the squeezing roller are both provided with grooves; the direction of the groove is parallel to the rotation axis of the shell breaking baffle.

4. The automated production system according to claim 2, wherein one end of the shell breaking baffle is fixed with a rack through a spindle, and the other end is connected with the rack through a spring; the rotation axis of the shell breaking baffle is parallel to that of the squeezing roller, the outer side of the shell breaking baffle is supported by a worm, the worm is matched with a worm wheel, and the worm wheel is connected with an adjusting handle; a guide baffle is arranged above the squeezing roller, and matched with the end of the conveying portion; grid plates are arranged above the conveying portion, and a gap between adjacent grid plates is larger than the diameter of the walnut.

5. The automated production system according to claim 1, wherein the kernel vibration grading device comprises a vibration base, the vibration base is fixedly provided with multiple layers of vibration screens, and the screen pores of various vibration screens are different in size; the vibration base is fixedly connected with a vibration motor, the screen pores of the multiple layers of vibration screens are gradually reduced from top to bottom; the vibration motor is arranged in a set inclined angle, so that the multiple layers of vibration screens are vibrated in an inclined manner.

6. The automated production system according to claim 5, wherein the vibration screen comprises a screen, one side portion of the screen is provided with a discharging outlet, and other three side portions are all fixed with steel structure frames; the screen is provided with a plurality of alternately arranged screen pores;
the bottom of the vibration base is arranged on a support frame, and a spring is arranged between the support frame and the vibration base;
the discharging outlet of the vibration screen on the uppermost layer is connected with an extension plate, the extension plate extends above a secondary shell breaking transfer stage, and the secondary shell breaking transfer stage transfers received materials to the shell breaking device; the discharging outlets of vibration screens on other layers are all connected with the negative-pressure shaking and sorting devices.

7. The automated production system according to claim 1, wherein the negative-pressure shaking and sorting device comprises a vibrostand, a secondary negative-pressure separation assembly is arranged above one side of the vibrostand, and the end of the vibrostand at this side is also provided with a transfer stage; the vibrostand comprises a vibration screen, a vibration motor is arranged at the bottom of the vibration screen, and mesh pores are formed in the vibration screen corresponding to the secondary negative-pressure separation assembly;
the bottom of the vibration screen is arranged on the support frame, and the spring is arranged between the support frame and the vibration screen; the height of the support frame corresponding to the secondary negative-pressure separation assembly is lower than heights of other positions; the secondary negative-pressure separation assembly comprises two negative-pressure shell sucking tables arranged in parallel, the negative-pressure shell sucking table comprises a barrel vertically arranged at the bottom and corresponding to the upper part of the vibrostand, and the top of the barrel is connected with the negative-pressure separation device.

8. The automated production system according to claim 1, wherein the negative-pressure separation device comprises a plurality of negative-pressure separators arranged in parallel, and the negative-pressure separators are communicated with a slagging blower through channels; the negative-pressure separators are also communicated with the negative-pressure shaking and sorting devices through pipelines, and the transfer stage is arranged under the negative-pressure separators;
the negative-pressure separator comprises a negative-pressure cavity, the top of the negative-pressure cavity is provided with an opening to be communicated with the channel, and the side portion of the negative-pressure cavity is provided with an interface to be communicated with the pipeline; the bottom of the negative-pressure cavity is provided with an opening to be communicated with a drum, rotatable blades are arranged inside the drum, and the bottom of the drum is provided with an outlet; a filter plate is arranged at the opening on the top of the negative-pressure cavity; two transfer stages are arranged under the negative-pressure separation device in parallel, and the transfer directions of the two transfer stages are opposite.

9. The automated production system according to claim 1, wherein the automated production system also comprises a feeding device for feeding the shell breaking device, the feeding device comprises a storage hopper, the side portion of the storage hopper is provided with an inclined transfer belt, and conveyor baffles are arranged at two sides of the transfer belt; the automated production system also comprises a lift feeding device arranged between the negative-pressure shaking and shell breaking device and the kernel vibration grading device, the lift feeding device comprises the inclined transfer belt on which a conveyor baffle vertical thereto.

10. The automated production system according to claim 1, also comprising the negative-pressure shaking and shell breaking device arranged between the shell breaking device and the kernel vibration grading device, the negative-pressure shaking and shell breaking device is connected with the negative-pressure separation device, the negative-pressure shaking and shell breaking device comprises the vibration screen, and a negative-pressure suction port is correspondingly arranged above the vibration screen; the vibration motor is arranged at the bottom of the vibration screen, the vibration screen is supported on the base, the spring is arranged between the base and the vibration screen, and a plurality of screen pores are formed in the vibration screen corresponding to the negative-pressure suction port.
